(19) United States
(12) Patent Application Publication
(10) Pub. No.: US 2018/0000287 A1
(43) Pub. Date: Jan. 4, 2018

(54) LOW OIL USAGE TURKEY FRYER

(71) Applicants: Alan BACKUS, Los Angeles, CA (US); Marici IULIUS, Las Vegas, NV (US)

(72) Inventors: Alan BACKUS, Los Angeles, CA (US); Marici IULIUS, Las Vegas, NV (US)

(21) Appl. No.: 15/693,810

(22) Filed: Sep. 1, 2017

Related U.S. Application Data
(63) Continuation-in-part of application No. 15/636,994, filed on Jun. 29, 2017.
Application No. 15/636,994 is a continuation-in-part of application No. 15/614,746, filed on Jun. 6, 2017.
Application No. 15/614,746 is a continuation of application No. 15/297,788, filed on Oct. 19, 2016.
Application No. 15/297,788 is a continuation-in-part of application No. 15/142,072, filed on Apr. 29, 2016.

(51) Int. Cl. A47J 37/12

(52) U.S. Cl. CPC A47J 37/129; A47J 37/1285; A47J 37/1261; A47J 37/128

(57) ABSTRACT

Embodiments to deep fat fry comestibles, including large food items. Such embodiments potentially being versatile enough to at least: deep fry, steam, bake, slow cook, and boil foods. Embodiments comprising contained food support vessels immersed into frying temperature cooking liquid baths, as well as boiling water, as well as hot air. Automatic fryer cleaning systems, utilizing food support vessels which drain through filter media. Contained food support vessels capped by lids. Unitary filter media configured to selectively remove debris and pollutants from both gasses and liquids exiting food support vessels. Condensation filtering into easy to empty and clean collection cups. Safety cooking liquid overflow protection into easily to empty and clean cups. A versatile, compactable funnel which may double as a cutting and food preparation surface.

### CROSS-REFERENCE TO RELATED APPLICATIONS

This application is a continuation-in-part of U.S. application Ser. No. 15/636,994, filed Jun. 29, 2017, which is a continuation-in-part of U.S. application Ser. No. 15/614,746, filed Jun. 6, 2017, which is a continuation of U.S. application Ser. No. 15/297,788, filed on Oct. 19, 2016, which is a continuation-in-part of U.S. application Ser. No. 15/258,453, filed Sep. 7, 2016. All of which are incorporated herein by reference.

### TECHNICAL FIELD

This application relates generally to food cookers. The application relates more particularly to deep frying of poultry or fowl foods.

### BACKGROUND

Devices to deep fry foods have been around for at least as long as historical records have been kept. Early devices were simply pots filled with oil hung over an open fire. Later devices merely replaced the open fire with a gas or electric range top. Still later devices were standalone dedicated deep fryers which plugged into wall current and generally had thermostats and thermal overload protections.

Around the beginning of the 1930s, in the southeastern United States, people started frying turkeys in cleaned out 55 gallon oil drums supported over an open fire. These eventually evolved into specialized turkey fryers with custom-made 2½ to 5 gallon and more capacity cooking vessels, suspended above open-flame gas-fired burners on, often on unstable metal support bases.

Around the beginning of 2000, an indoor variant of these early gas-fired turkey fryers became available. Because these were electrically powered and sold to the general public, they fell under household safety standards, such as, as an example, Underwriter Laboratories 1083, which required various safety features, including: thermostats, thermal overloads, stability standards, oil usage and food size restrictions, etc.

Turkey fryers intended for home use had, in general, tougher, and harder to meet personal safety standards, than standards for commercial units used in restaurants and other commercial environments. These included specifically at least: an oil capacity not to exceed 5 L (5.28 quarts), and a lifted food capacity, including food support, which could not exceed 15 pounds.

These tougher standards were predicated at least in part on the concept that in a commercial environment, generally adult and trained professionals only would be using the equipment, as opposed to the potential in a home environment for at least children and seniors to be operating the equipment. These home use safety standards also took into account that in homes it was likely at least children and pets might be in the device use environment.

Deep frying is inherently at least a little bit dangerous, at minimum because all deep frying involves the use of high temperature oil, generally exceeding 350° F., with the potential of the hot oil splattering, or pouring all at once, onto an individual.

Splattering of hot oil may be particularly a problem when often moist foods are first introduced into the hot cooking oil.

A second acknowledged problem of deep frying foods is that the frying process often dries out the foods because the hot cooking oil boils all the moisture from the foods.

### BRIEF DESCRIPTION OF THE DRAWINGS

Various embodiments will become better understood with regard to the following description, appended claims and accompanying drawings wherein:

FIG. 1 is a forward perspective view of embodiment 100.

FIG. 2 is a wireframe side view of embodiment 100.

FIG. 3 is an exploded perspective view of embodiment 100.

FIG. 4 is an exploded perspective view of embodiment 100, taken from below and behind embodiment 100.

FIG. 5 is a section view of embodiments 146 and 147, as indicated in FIGS. 6 and 7.

FIG. 6 is a plan view of embodiments 100 and 147.

FIG. 7 is a plan view of embodiments 146 and 148.

FIG. 8 is a side view of turkey 168 resting on a horizontal support surface.

FIG. 9 is a plan view of turkey 168 resting on its side inside food support vessel 170.

FIG. 10 is a partially exploded forward perspective of embodiment 182.

FIG. 11 is a forward perspective of embodiment 182.

FIG. 12 is a side section view of embodiment 182, as indicated in FIG. 11, with turkey 236 resting breast up in food support vessel 194, with vessel 194 disposed in its raised draining position.

FIG. 13 is identical to FIG. 12 except food support vessel 194 is lowered into frying hot cooking liquid 238.

FIG. 14 is identical to FIG. 12 except turkey 236 is rotated 180° so that it is disposed breast down.

FIG. 15 is identical to FIG. 13 except turkey 236 is rotated 180° so that it is disposed breast down.

FIG. 16 is a section view of embodiment 182, as indicated in FIG. 11, being used for food steaming.

FIG. 17 is a detail of FIG. 16, as indicated in FIG. 16.

FIG. 18 is a frontal section view of embodiment 182, as indicated in FIG. 11.

FIG. 19 is a detail of FIG. 18, as indicated in FIG. 18.

FIG. 20 is a partially exploded perspective showing food support vessel 194 and lid 208.

FIG. 21 is a plan view detail as indicated in FIG. 22.

FIG. 22 is a perspective showing lid 208 unlocked from food support vessel 194.

FIG. 23 is a perspective view detail as indicated in FIG. 22.

FIG. 24 is a perspective showing lid 208 locked onto food support vessel 194.

FIG. 25 is a plan view detail of FIG. 24, as indicated in FIG. 24.

FIG. 26 is a perspective view of embodiment 182.

FIG. 27 is a perspective detail of FIG. 24, as indicated in FIG. 24.

FIG. 28 is a frontal exploded perspective of embodiment 182.

FIG. 29 is an exploded perspective of embodiment 182, taken from behind and below embodiment 182.

FIG. 30 is a partially exploded perspective of embodiment 246.

FIG. 31 is a perspective of embodiment 246 with food support vessel 250 raised to its draining position.

FIG. 32 is a perspective of embodiment 246 with food support vessel 250 lowered for cooking.

FIG. 33 is a plan view of embodiment 246, showing lid latch 286 in its locked (solid lines) and unlocked (dotted lines) positions.

FIG. 34 is a detail of FIG. 38, as indicated in FIG. 38, with liquid containment vessel 254 inserted into outer enclosure 252.

FIG. 35 is a detail of FIG. 36, as indicated in FIG. 36.

FIG. 36 is a cross-section of embodiment 246, as indicated in FIG. 32.

FIG. 37 is a detail perspective of FIG. 36, as indicated in FIG. 36.

FIG. 38 is a frontal exploded perspective of embodiment 246.

FIG. 39 is an exploded perspective of embodiment 246, taken from behind and below embodiment 246.

FIG. 40 is a perspective of embodiment 328 in its funnel configuration.

FIG. 41 is a perspective of embodiment 328 in its funnel configuration being used to refill cooking oil container 344.

FIG. 42 is a plan view of pliable sheet 334 flattened out, including knife 348, which, as a non-limiting and non-exhaustive example, might be used in conjunction with flattened out pliable sheet 334 for food preparation.

FIG. 43 is a perspective of pliable sheet 334 flexed into a U-shaped trough to facilitate handling of foods prepared on the surface of pliable sheet 334.

### DETAILED DESCRIPTION

FIGS. 1 through 4—Embodiment 100:

FIGS. 1 through 4 shows embodiment 100, as with all other fryer embodiment shown herein, which is an indoor or outdoor use deep fryer, with a capacity to cook large unitary foods, including, but not necessarily limited to, a Thanksgiving Day sized, feed a family of five, turkey 102.

Embodiment 100, as with all other fryer embodiment shown herein, is also versatile enough to cook both large and small amounts of unitary and plural, large and small food items, and to cook such food items by immersing them in hot cooking liquid all at once, or in multiple stages where only a portion of the food items are cooked at one time.

Fundamentally, embodiment 100 comprises an elongated food support vessel 104, with a plan view aspect ratio of 1.7 to 1 or greater, (that is, for every inch in width food support vessel 104 has in plain view, it must have 1.7 inches in depth or more) with generally planar, trough-like, sidewalls 116 118 which have radiused end walls at both ends 106 108. The floor 110 is also fully radiused. Generally spherical connecting surfaces 112 114 transitioning between the radiused end walls at ends 106 108, and radiused floor 110, complete the outer walls of the food support vessel 104.

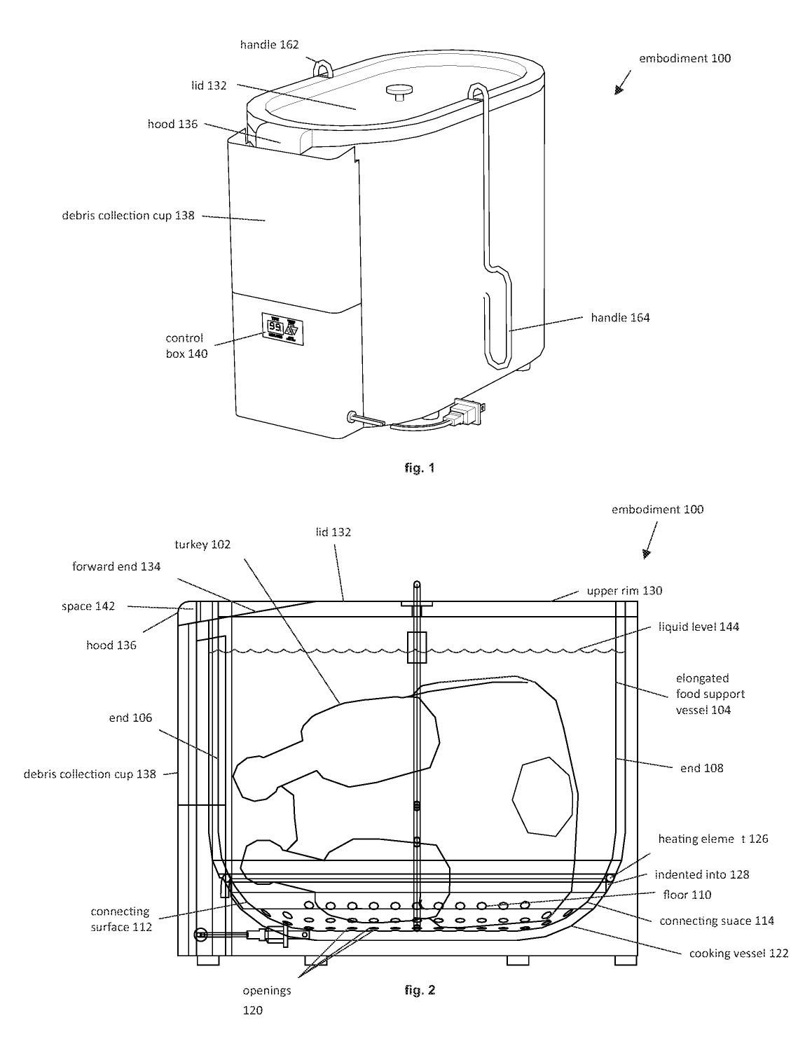

This structure provides support for large fowl, such as turkey 102, to be held on its side, with one wing and one leg downward, as illustrated in FIGS. 2, 3, 4, 5, 6, 7 and 9.

Alternatively, depending on the constructed size of embodiment 100, embodiment 100 may support food items, including turkey 102, in a variety of positions for cooking. As non-limiting and non-exhaustive examples, turkey 102 might rest on its breast, or its back, or its tail, or neck down, for cooking. Likewise, other food items to be cooked in embodiment 100, might be disposed in a variety of advantageous dispositions.

Embodiment 100, as with all fryer embodiments shown herein, may be constructed at any useful scale, including sizes both larger and smaller than those illustrated herein.

The sidewalls of food support vessel 104, including 116 118 106 and 108, are not perforated, and are comprised sheet-like surfaces. The term “not perforated” herein shall mean that 98% or more of its surface area is solid.

The interior surfaces of food support vessel 104 may be advantageously coated with a nonstick surface, both to at least facilitate food removal and to ease cleanup. This is also true for all fryer embodiments shown herein.

Floor 110 is perforated with openings 120 which regulate fluid flow into and out of the interior of support vessel 104. Such perforations 120 occur within the lower 30% of the height of food support vessel 104.

Cooking vessel 122 generally fully surrounds the exterior surfaces of food support vessel 104 with walls 124 which are generally parallel at an equidistant to the exterior walls of food support vessel 104.

Electrically energized rod-type heating element 126 is indented into 128 the outer walls of cooking vessel 122.

User operated control box 140 directs the operation of heating element 126 including thermostatically energizing heating element 126, and timing the duration of its operation.

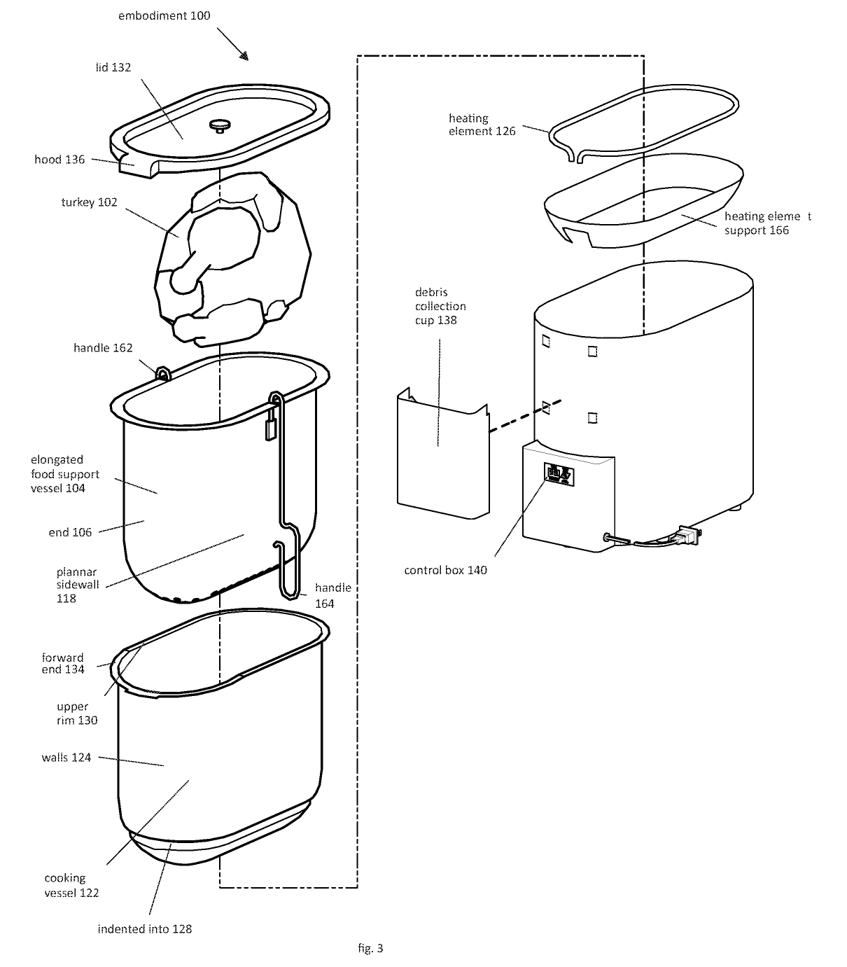

Upper rim 130 of cooking vessel 122 is generally planar to couple face-to-face with generally flat lid 132. However, on forward end 134 (FIG. 3), upper rim 130 bends downward forming space 142 between forward end 134 and lid 132 (FIG. 2) which allows fluids to exit from within a cooking vessel 122, to its exterior.

Hood 136, formed in the forward portion of lid 132, helps direct liquid and gaseous fluids exiting cooking vessel 122 through space 142, downward into user dismountable debris collection cup 138, where the exiting material is stored for eventual disposal or reuse. Debris collection cup 138 may advantageously be translucent or transparent to allow users to view the quantity and identity of its debris content.

As with all debris collection cups shown herein, oil taken from debris collection cup 138 may contain water components. Such components are purified out of the oil upon reuse by being boiled and released in the form of steam.

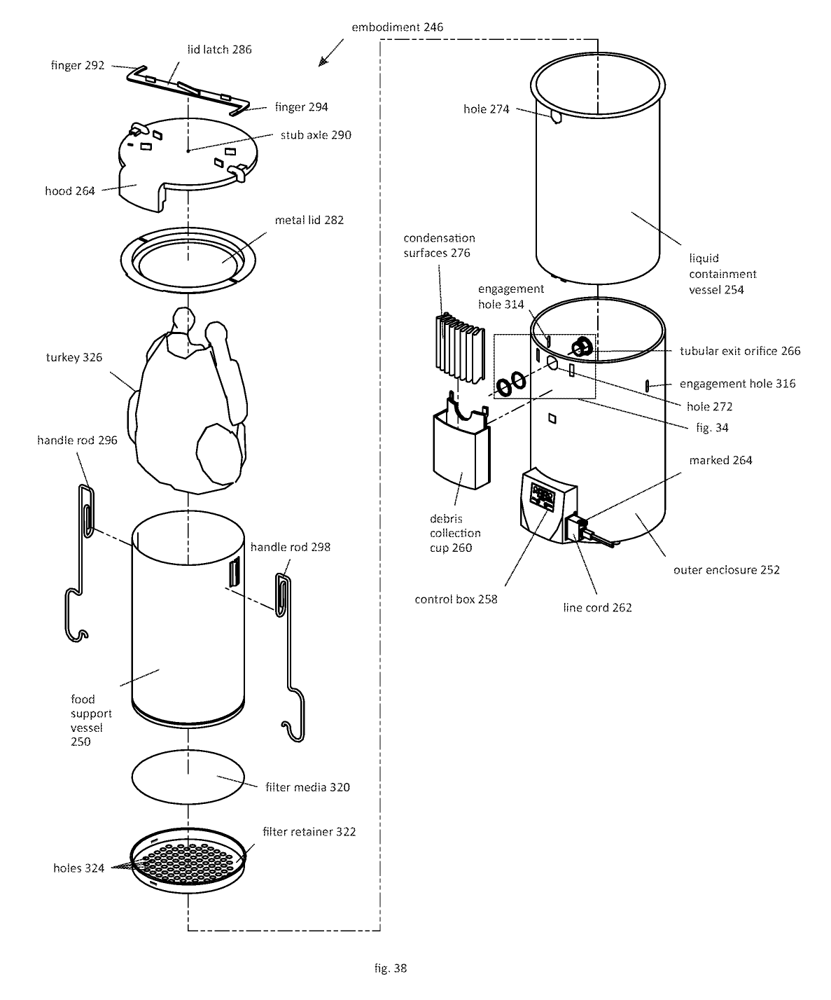

Interior surfaces within debris collection cup 138, help condense out pollutants and at least thus filter vapors and gasses exiting cooking vessel 122. Additional surfaces may be placed within debris collection cup 138 to assist condensation removal of contaminants. Such surfaces may be similar to those described and shown in FIG. 38 (condensation surfaces 276).

As shown by liquid level 144 (FIG. 2), embodiment 100 is capable of fully immersing foods being fried, such as, by way of a non-limiting and non-exhaustive example, Thanksgiving day size turkey 102. Embodiment 100 may also cook foods, using less cooking liquid, by cooking only a portion of a food at a time.

Embodiment 100, as with all fryer embodiments herein, may deep fry any suitable food which the embodiment is able to properly contain.

When cooking a large fowl, such as by way of a non-limiting and non-exhaustive example, turkey 102, embodiment 100 may place the fowl on its side, with one wing and one leg down, as illustrated in FIGS. 2, 3, 4, 5, 6, 7 and 9. This may advantageously decrease the frying liquid needed for cooking.

### FIGS. 5, 6, and 7—Embodiments 146, 147, and 148:

FIGS. 5, 6, and 7, in combination with FIGS. 1 through 4, illustrate embodiments 146, 147, and 148.

In general, embodiments 146, 147, and 148 are variants of embodiment 100 with similar elements performing similar functions.

However, embodiment 146 differs from embodiment 100, because instead of having the profile shown in FIG. 2, which is the profile for embodiment 100, embodiment 146 has the profile shown in FIG. 5, which differs because floor 150 of food support vessel 152 (FIG. 5), as well as cooking vessel floor 154, unlike similar elements for embodiment 100, are both inclined, descending fore to aft.

This may decrease frying oil usage for certain foods. As non-limiting and non-exhaustive examples, for large fowls, such as turkey 102 illustrated, or for a leg of lamb, or for other foods, etc.

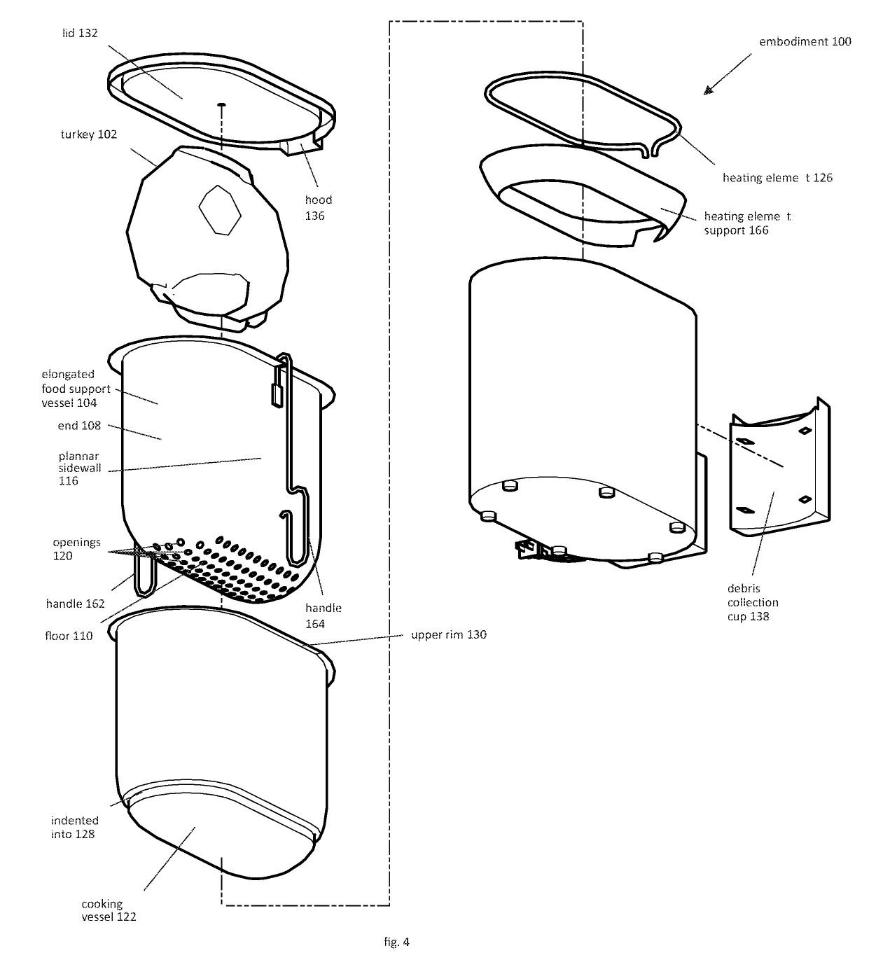

Embodiment 147 is generally identical to embodiment 146, except instead of having a plan view of FIG. 6 as embodiment 146 does, embodiment 147 has the plan view of FIG. 7, which tapers from being wide at rear 156 to being narrow at front 158.

This again may help reduce frying liquid usage for certain foods when disposed in specific prescribed dispositions. As a non-limiting and non-exhaustive example, Thanksgiving turkey 160, may use less frying liquid than if it were placed horizontally on its breast.

Embodiment 148 is generally identical to embodiment 100, except its plan view is that shown in FIG. 7, with both its cooking and food support vessels tapering from being narrow at front 158, to being wide at rear 156.

Again, this may increase frying oil use efficiency, for certain foods under certain conditions. As a non-limiting and non-exhaustive example, cooking turkey 160 on its side, with one wing and one leg down, as shown in FIG. 7, may use less frying liquid than cooking the same turkey horizontally on its breast.

In use, embodiments 100, 146, 147, and 148 operate similarly. Using embodiment 100 to typify, as a non-limiting and non-exhaustive example, food to be fried, such as turkey 102, is placed into elongated food support vessel 104 and lid 132 is placed to cap and contain the food within food support vessel 104.

The seal between lid 132 and elongated food support vessel 104 may be totally occlusive, or partially occlusive, such as, for a non-limiting and non-exhaustive example, in peak discharge situations, blocking at least 50% of exiting vapors and gasses from leaving food support vessel 104 through the seal.

Or the seal may provide minimal blockage.

Food support vessel 104, along with contained food 102 is then lowered into cooking vessel 122, which contains prescribed amounts of cooking liquid preheated to cooking temperatures.

Openings 120 in floor 110 help regulate how fast frying liquid can enter food support vessel 104 and how fast liquids and vapors may exit food support vessel 104.

This regulation in turn helps limit the amount of dangerous bubbling and splattering taking place exterior to food support vessel 104.

Lid 132 also caps cooking vessel 122 and helps prevent gasses, liquids, and vapors from leaving cooking vessel 122, except through space 142, where exiting materials are directed downward into debris collection cup 138 for filtering and storage.

Debris collection cup 138 may contain condensation surfaces within it, such as, by way of non-limiting and non-exhaustive examples, corrugated or other convoluted surfaces of perforated or non-perforated materials, potentially including: plastics, metals, ceramics, stones, pebbles, activated charcoal particles, metal wool, nonwoven plastics, screening, perforated metal, perforated plastics, or other suitable materials. These surfaces may be easy to clean such as in a dishwasher, or close washer, or sink, etc.

Debris collection cup 138 may also contain more conventional filtering material such as activated charcoal or impregnated nonwoven plastics, or woven fabrics, filter paper, or other filtering items

The food is left in the cooking temperature liquid for a predetermined amount of time which is adequate to cook the food, after which support vessel 104 and it's contain food, as a non-limiting and non-exhaustive example, turkey 102, are lifted out of the cooking liquid. The food is then removed from food support vessel 104 and served.

Alternatively, if only a portion of the food was cooked in the first cooking session, the above process may be repeated one or more times until all portions of the food are cooked.

The debris collection cup may dump out and reuse any collected overflow oil, and/or it may be simply cleaned out with its contents disposed of.

Marinades, spices, or other food treatments may be applied before, during, or after cooking.

Any suitable cooking liquids may be used. As a non-limiting and non-exhaustive example, pure olive oil is lower in undesirable fats and oils, and has an adequately high smoke point to allow cooking at 385° F. United States regulatory bodies, such as Underwriter Laboratories, prohibit cooking temperatures above 400° F. (UL 1083) for household use frying appliances.

Handles 162 and 164 may be disposed on opposite sides of food support 104, as shown at least in FIGS. 1, 3 and 4, or they may be placed on either end of the food support vessel, or they may both be placed on the same side of one of the long sides of the food support vessel.

Alternatively, a bail handle, such as commonly used on water buckets, may be used and attached to opposing sides or opposing ends of either elongated food support vessel 104 or food support vessels 152.

Heating element support 166 may help physically hold heating element 126 in place, and/or may increase heating element efficiency (i.e. the amount of electricity required to raise the temperature of the cooking liquid) by reflecting back to the cooking vessel otherwise wasted heat.

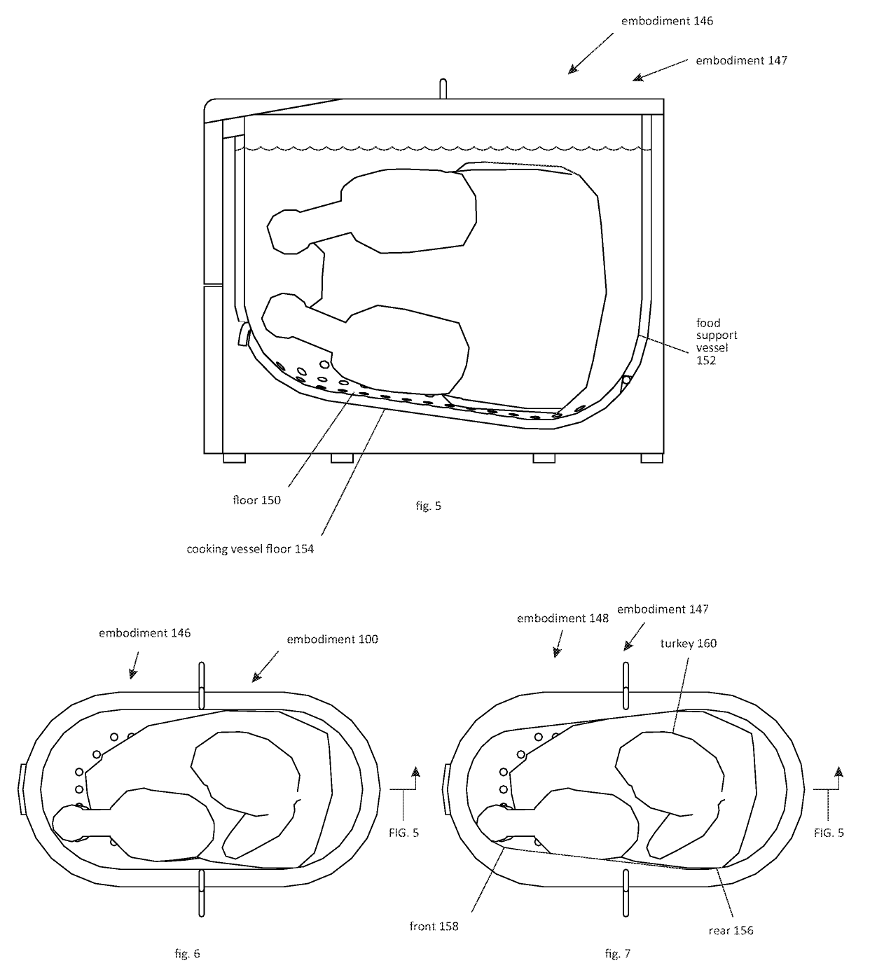

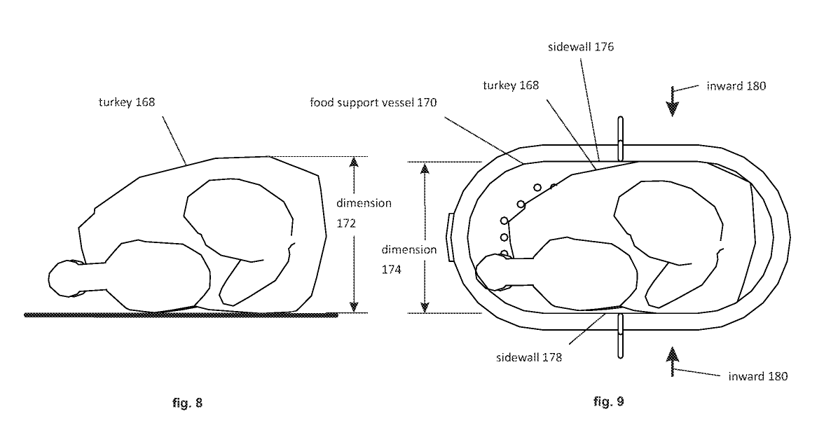

FIGS. 8 and 9 show that when supporting large pieces of food, such as Thanksgiving day size turkey 168, food support vessel 170, which is similar to the food support vessels shown in embodiments 100, 146, 147, and 148, may compress the top to bottom dimension of turkey 168, as shown in FIG. 8 (side to side dimension when turkey 168 is in food support vessel 170 as shown in FIG. 9) by 3% or more.

As a non-limiting and non-exhaustive example, if dimension 172 (FIG. 8) was 8 inches, dimension 174 (FIG. 9) might be 7.76 inches (97% of 8 inches) or less, due to the inward 180 compressive forces exerted by sidewalls 176 and 178 of food support vessel 170.

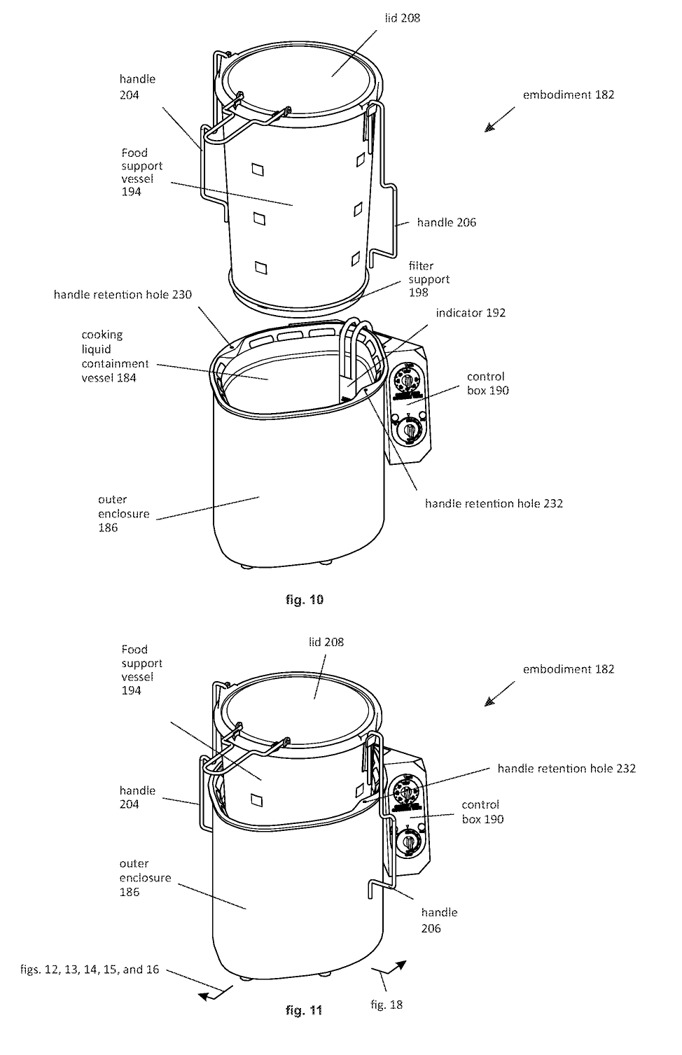

FIGS. 10 through 29—Embodiment 182:

FIGS. 10 through 29 show embodiment 182, which is basically a deep fryer containing a user removable enclosed food support vessel.

More specifically, embodiment 182 comprises cooking liquid containment vessel 184; configured to hold cooking temperature liquid and associated foods.

Cooking liquid containment vessel 184 is surrounded on its sides and bottom by outer enclosure 186, which positions and holds vessel 184 above a horizontal support surface.

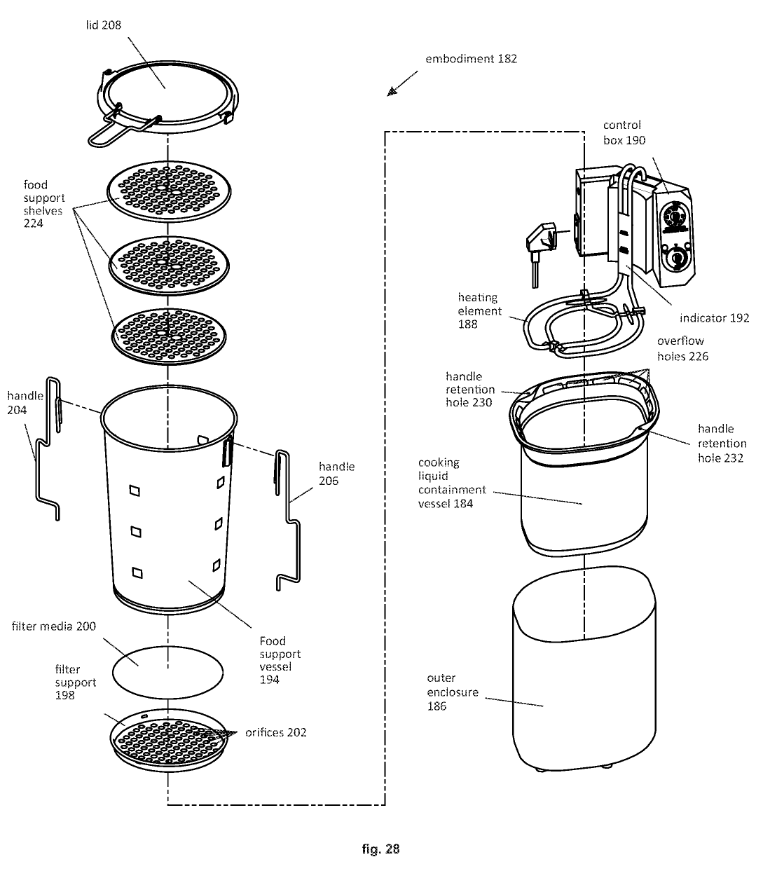

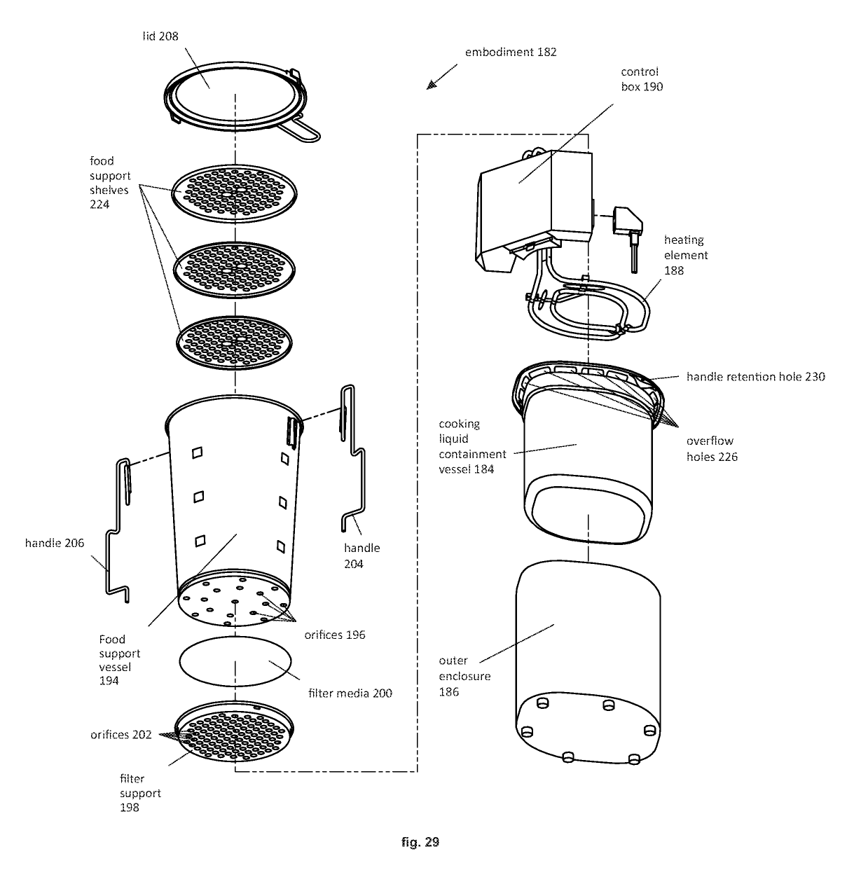

Overflow holes 226 (FIGS. 28 and 29) disposed proximate to the upper rim of vessel 184 help prevent any accidentally overflowing frying liquids from spilling onto supporting surfaces. Any overflowing liquids 228 are directed through holes 226, and are retained within outer enclosure 186 (FIGS. 13 and 15), where they can be stored for reuse or disposal.

Overflow holes 226 may be used as an easy means of cooking liquid measurement by simply overfilling cooking liquid containment vessel 184 and placing food within it. Any excess cooking liquid simply overflows out of holes 226 and is stored in the bottom of outer enclosure 186.

Electrically energized rod-type heating element 188 is disposed within containment vessel 184, proximate to its floor. Heating element 188 is thermostatically and duration regulated by control box 190.

Cooking liquid volume indicator 192 (FIGS. 10 and 28) couples to vertical segments of heating element 188 and has indices to provide users with easy to read visual indication of the volume of cooking liquid contained within vessel 184.

Food support vessel 194 is configured to hold and support foods, and to be user removably disposed within vessel 184 when cooking liquid heated to cooking temperatures by heating element 188 is contained within vessel 184.

Orifices 196 (FIG. 29) in the lower 30% of support vessel 194, help regulate gaseous and liquid fluid flows into and out of vessel 194.

Filter support 198 snaps onto the bottom of vessel 184 and holds filter media 200 above the floor of filter support 198 and below the floor of food support vessel 194 (see in particular FIG. 19).

Orifices 202 in filter support 198 (FIGS. 28 and 29), in combination with filter media 200 and orifices 196 in the floor of food support vessel 194, regulate gaseous and liquid fluid flow in and out of food support vessel 194.

User removable food support vessel handles 204 and 206 facilitate insertion and removal of food support vessel 194 into and out of containment vessel 184.

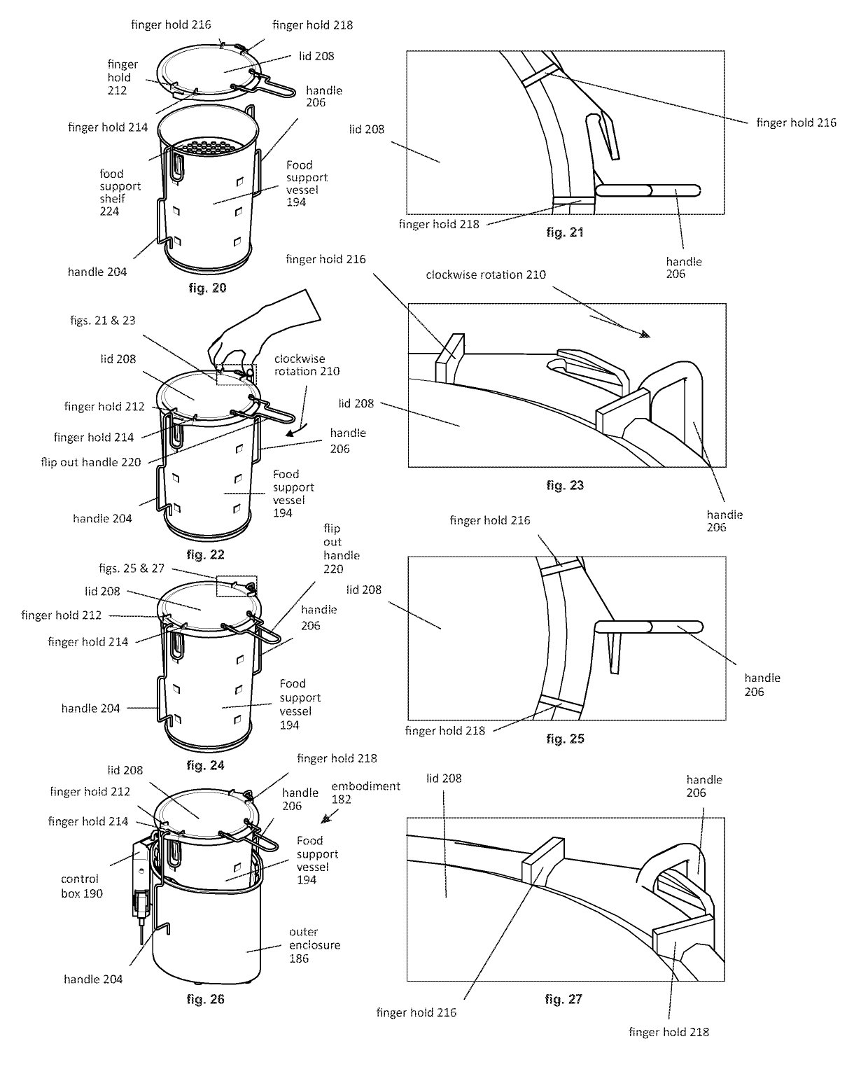

Lid 208 removably caps food support vessel 194, and locks into place through clockwise rotation 210 (FIGS. 20 through 27).

As shown particularly in FIG. 22, finger holds 212 214 216 and 218, in combination with the tops of handles 204 and 206, may be used to facilitate one-handed clockwise 210 rotation, as well as to facilitate one-handed counterclockwise rotation to remove lid 208.

Alternatively, flip out handle 220 may be used.

Lid 208 may totally block, block 90% or more of maximum flow, or provide less blockage of liquids and gasses exiting out of food support vessel 194. Such blockage may facilitate beneficial cooking results by retaining, liquids, flavors and juices within food support vessel 194 during cooking, and/or by containing heat and steam within food support vessel 194 while cooking is taking place, to more completely cook and tenderize food.

When cooking large foods, such as by way of a non-limiting and non-exhaustive example, a Thanksgiving Day size turkey, 40% or more of the outer surface of the food may make direct face-to-face contact with the interior walls of food support vessel 194. Such face-to-face contact may facilitate beneficial cooking results by helping block moisture, juices, and flavors from leaving such foods during cooking, thus making such foods moister, juicier, more tender and more flavorful.

Protuberances 222 (FIGS. 18 and 19) projecting inward from the side walls of food support vessel 194 allow removable mounting of food support shelves 224. Shelves 224 may be used during all forms of cooking with the embodiment, specifically including, but not limited to: deep frying, steaming, baking, slow cooking, and boiling.

During cooking with embodiment 182, and particularly when using embodiment 182 for deep frying, cooking activity is contained within food support vessel 184. Thus any splattering, bubbling, turbulence and splattering of cooking liquid is confined within food support vessel 184. This greatly reduces the likelihood of user injury. Splattering, bubbling, turbulence, etc. is generally minimized outside of food support vessel 184.

Cooking liquid which has been contaminated by cooking is automatically filtered through filter media 200 when food support vessel 194 is removed from cooking liquid containment vessel 184.

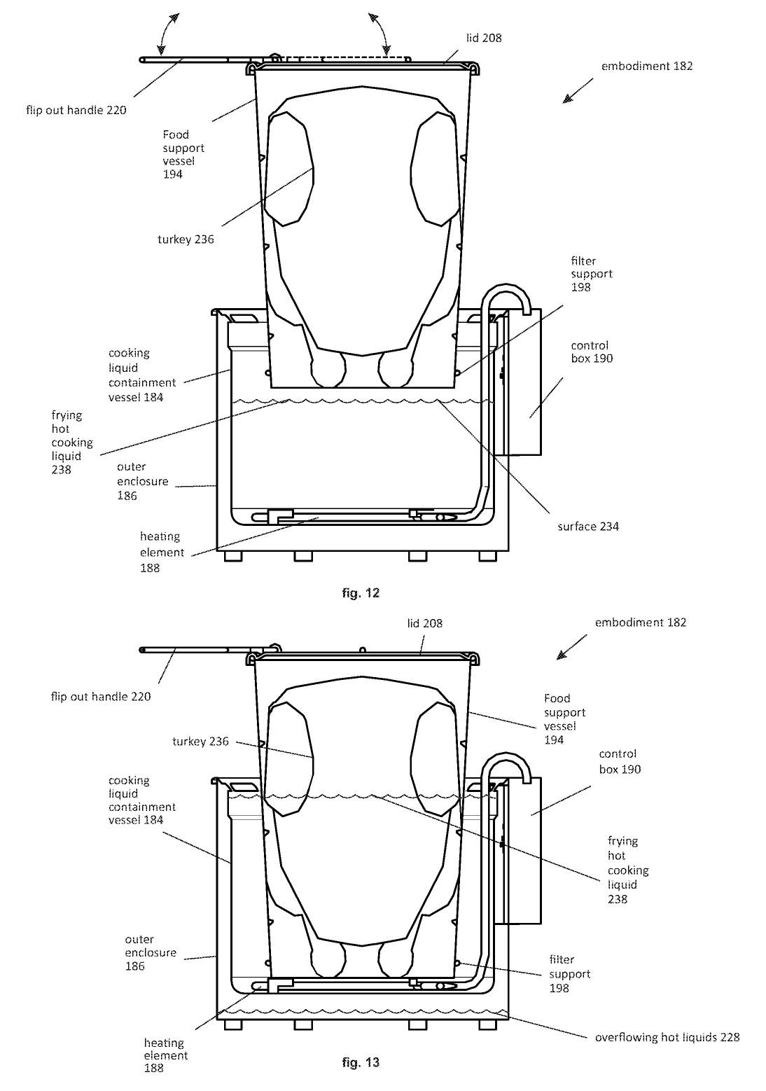

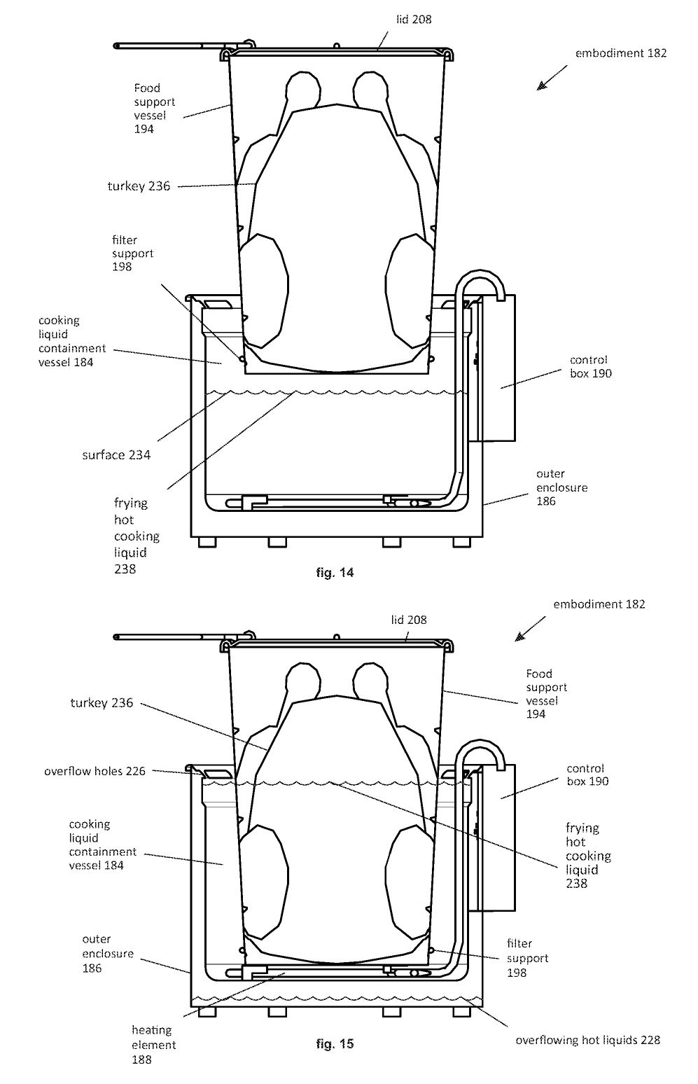

To help facilitate this, the ends of handles 204 and 206 may be inserted respectively into handle retention holes 230 and 232 (FIG. 28) disposed on the upper rim of cooking liquid containment vessel 184, as shown in FIGS. 12 and 14. In this raised position, the floor of food support vessel 184 is above the surface 234 (FIG. 28) of the cooking liquid. Leaving food support vessel 194 in this disposition for a period of time after cooking, allows an interval for cooking liquid to drain out of vessel 194 through filter media 200. This may extend the useful life of cooking liquid, and minimize cleanup by preventing unfiltered pollutants from collecting on the heating coil and interior surfaces of the cooking liquid containment vessel.

Filter media 200 may take many forms. As non-limiting and non-exhaustive examples: it may be course or fine screening; cloth; nonwoven material such as steel wool or stainless steel wool; or cotton batting; particles such as sand, metal filings or gravel or activated charcoal particles of various sizes; materials impregnated with activated charcoal or other substances; filter paper; a an intact rectangular paper towel; woven metal; or any other suitable material.

Embodiment 182 may cook foods in a single step, where the entire food is cooked all at once, or it may cook foods in two or more stages, where only a portion of the food is cooked at any single time.

As a non-limiting and non-exhaustive example: FIGS. 12 through 15 show Thanksgiving Day size turkey 236 being cooked in two steps.

FIGS. 12 and 13 show the first step, where turkey 236 is lowered into frying hot cooking liquid 238 feet first. It is left in this position long enough for cooking to occur, after which it is removed and reinserted into frying hot cooking liquid 238 breast down long enough for cooking of the second half of turkey 236 to occur, as shown in FIGS. 14 and 15.

Smaller foods may be cooked in a single immersion, and larger foods may be cooked in two, three or more steps, cooking only a portion of food at a single time.

Orientation of food being cooked, whether in one or multiple stages, may be directed to whatever is convenient. This is true of all fryer embodiments shown herein. As a non-limiting and non-exhaustive example, a small chicken could be cooked with its feet down, with its feet up, on its side resting on one of its legs and one of its wings, on its back, on its breast, diagonally, or in whatever orientation is advantageous, given the size and shape of the chicken.

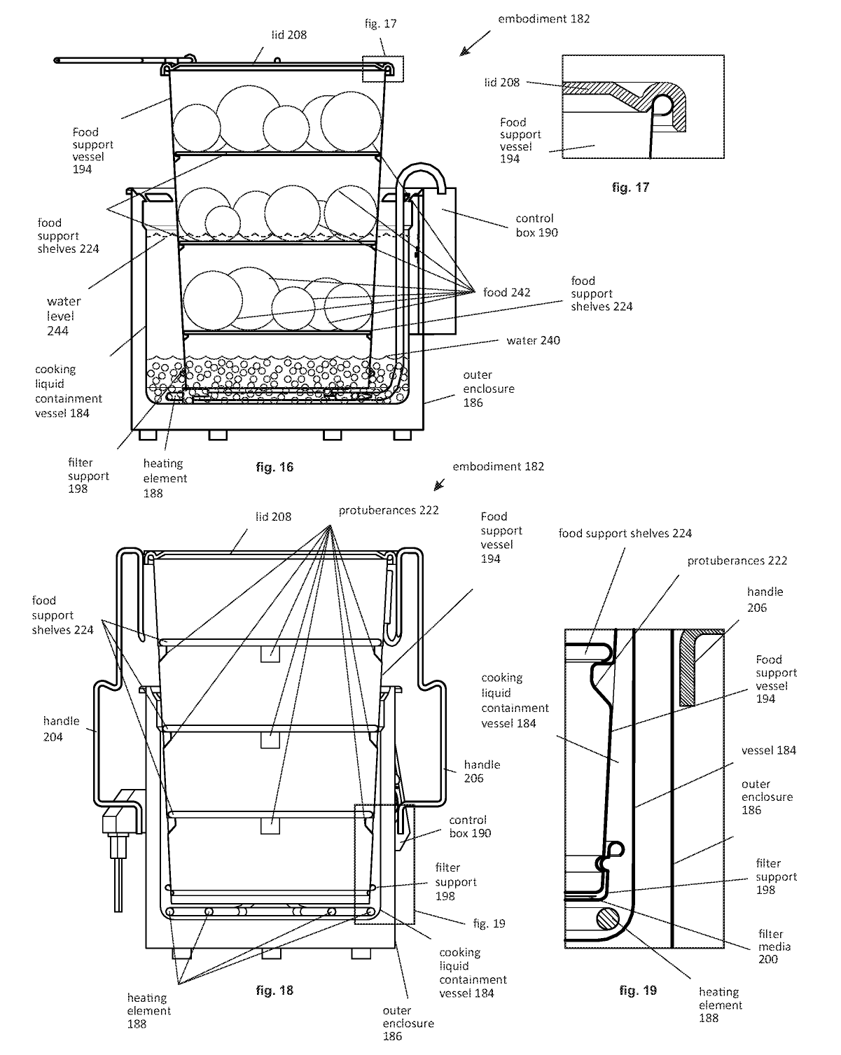

FIG. 16 shows a non-limiting and non-exhaustive example of embodiment 182 being used for food steaming. Water 240 is placed within cooking liquid containment vessel 184 and brought to a boil using heating element 188 activated by control box 190. Filter media 200 may or may not be in place during this operation.

Food 242 is placed on food support shelves 224 and food support vessel 194 is then lowered into cooking liquid containment vessel 184 where it remains until food steaming has occurred. During this period, food 242 is held above boiling water 240 by shelves 224. Lid 208 helps retain steam within food support vessel 194 during the cooking.

In a variant of this, embodiment 182 may be used for boiling foods simply by placing the foods on the floor of food support vessel 194 and/or on one or more of its lower shelves, and raising the water level to 244.

Food support vessel 194 may mount more than the three food support shelves 224 shown, simply by adding more shelves 224 and more protuberances 222.

After steaming or boiling, the ends of handles 204 and 206 may be placed respectively into handle retention holes 230 and 232 (FIG. 28) so that food support vessel 194 is disposed above any cooking liquid within cooking liquid containment vessel 184, resulting in any excess liquid within food support vessel 194 being drained back into cooking liquid containment vessel 184. This may or may not be true when embodiment 182 is used for boiling, depending on water level 244 used for the boiling.

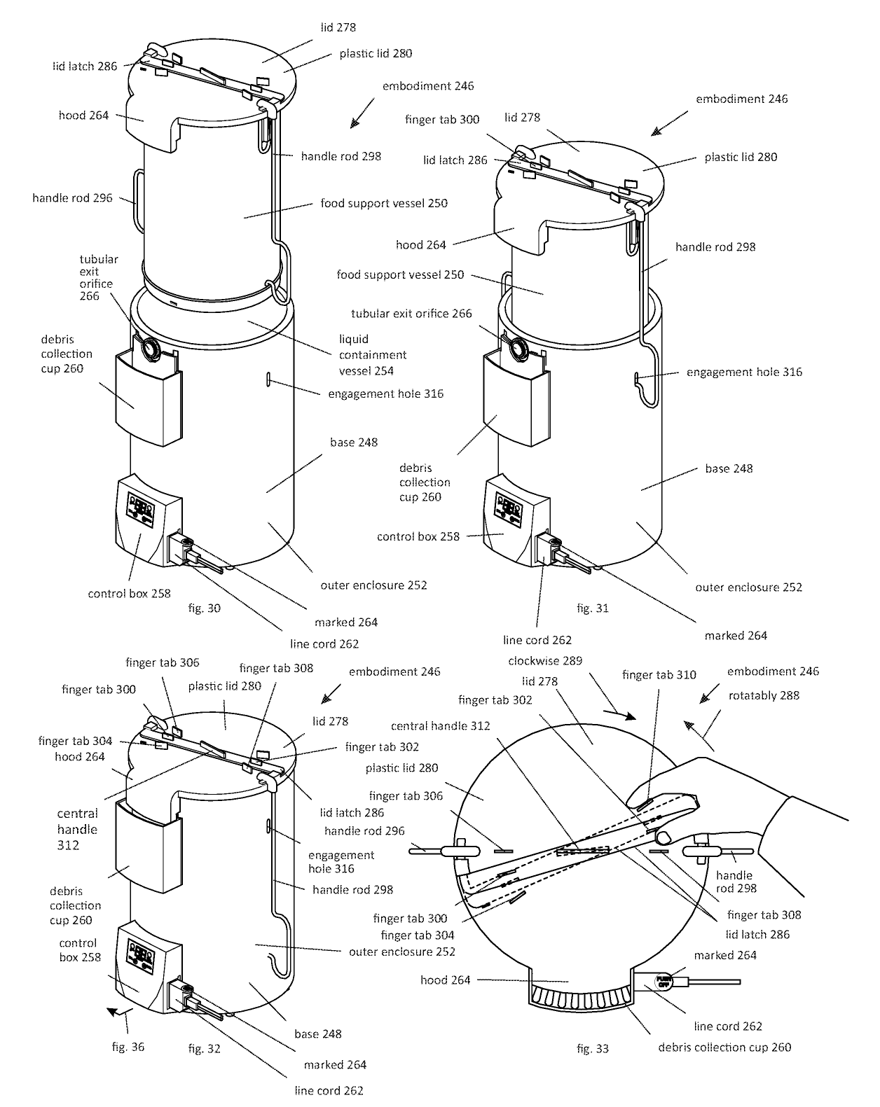

FIGS. 30 through 39—Embodiment 246:

FIGS. 30 through 39 show embodiment 246 which is configured to deep fry both large and small food items with one submergence in hot cooking liquid. It also may deep fry food items in multiple hot cooking liquid submergences. In addition, embodiment 246, as well as variants of all other fryer embodiments herein, may at least: boil, steam, slow cook, and bake comestibles.

Fundamentally, embodiment 246 is comprised of base 248, which from time to time surrounds and mounts removable, contained food support vessel 250.

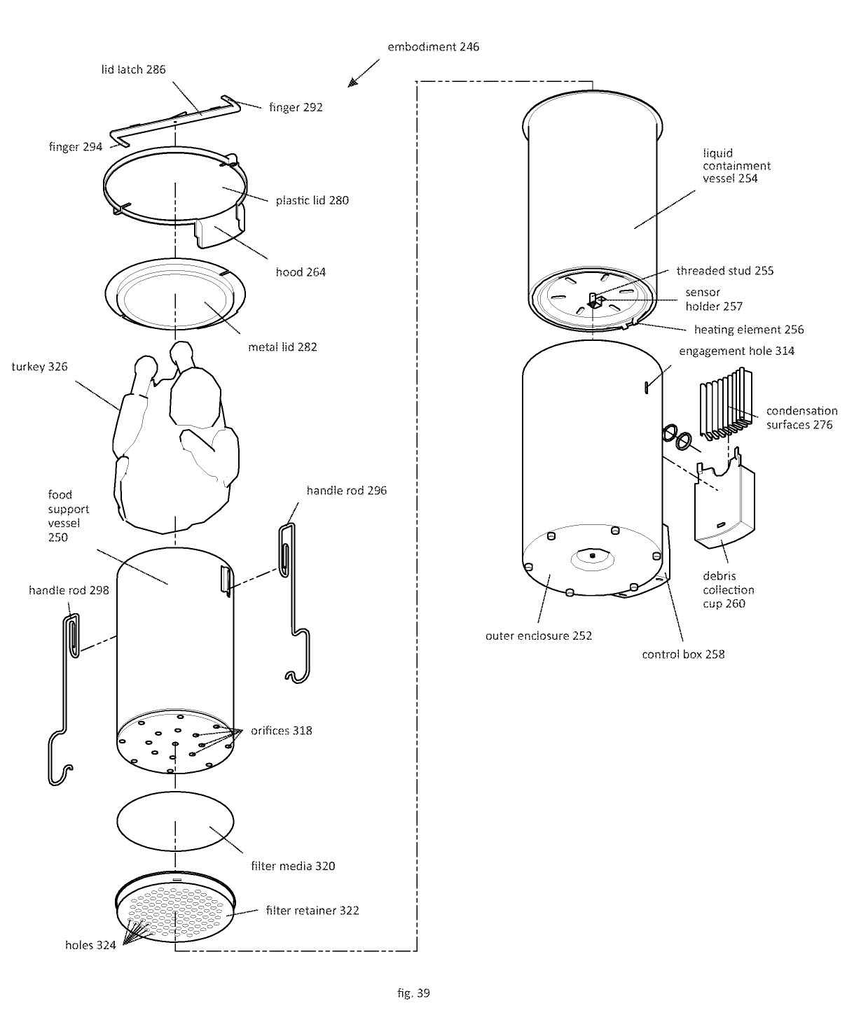

Base 248 is comprised of outer enclosure 252 which mounts liquid containment vessel 254 using threaded stud 255 (FIGS. 36 and 39) to pull the upper rim of liquid containment vessel 254 tightly onto the upper rim of outer enclosure 252 (FIG. 36).

Threaded stud 255 also mounts thermostat and thermal overload sensor holder 257 which mechanically holds thermostat and thermal overload sensors against the floor of liquid containment vessel 254 (FIG. 39).

Vessel 254 mounts rod-type electrical heating element 256 indented upward into its floor (FIGS. 36 and 39).

Heating element 256 is configured to heat associated foods within food support vessel 250 to cooking temperatures.

Heating element 256 is time-duration and thermostatically regulated by control box 258 which is mounted on a forward lower portion of outer enclosure 252.

Magnetically coupled line cord 262 is disposed on the right side of control box 258, and is marked 263 to indicate that pushing on the plug will turn off the embodiment.

Removably mounted on a forward portion of outer enclosure 246, and mounted above control box 258, is removable debris collection cup 260. Debris collection cup 260, through accepting and condensing gaseous outflow from within liquid containment vessel 254, may help to filter out debris, including oils, greases, and orders from the gaseous outflow. Helping in this condensation and filtration are condensation surfaces 276.

Condensation surfaces 276 may comprise, by way of non-limiting and non-exhaustive examples, corrugated or other convoluted surfaces, perforated or non-perforated materials, plastics, metals, ceramics, stones, pebbles, metal wool, marbles, nonwoven plastics, woodchips, plant fibers, activated charcoal, desiccants, deodorizers, cloth, screening, perforated metal or plastic, or other suitable materials. These surfaces may be easy to clean such as in a dishwasher, or clothes washer, or sink, etc.

Debris collection cup 260 may also collect liquid overflowing out of liquid containment vessel 254 for later reuse or disposal or for other purposes.

Gaseous and liquid debris exiting liquid containment vessel 254 and into debris collection cup 260, pass through tubular exit orifice 266 which mounts screw-thread 268 compressively between, outer enclosure 252 and liquid containment vessel 254; and penetrates through hole 272 in outer enclosure 252 and hole 274 in liquid containment vessel 254.

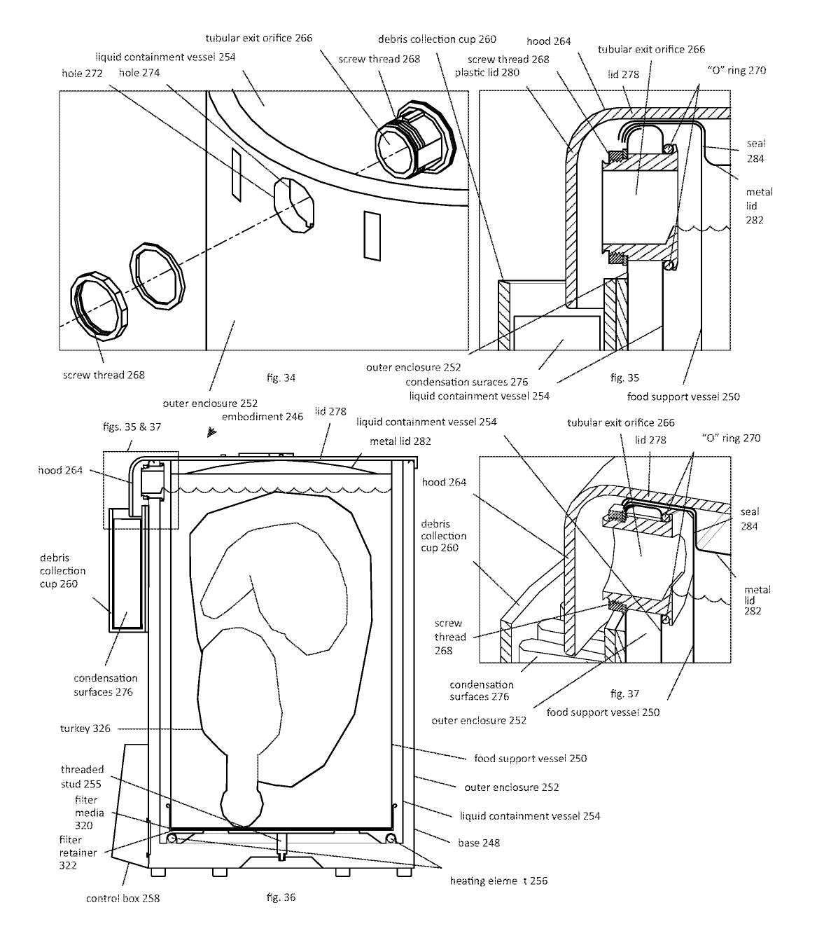

“O” ring 270 (FIGS. 35 and 37) helps make a liquid tight seal between the interior facing wall of liquid containment vessel 254 and the inside facing portion of orifice 266. Exit orifice 266 limits the amount of cooking liquid contained within liquid containment vessel 254 by overflowing any excess. This may be used as an easy cooking liquid measurement system by over filling liquid containment vessel 254 with cooking liquid, then immersing the associated food to be cooked into the overfilled liquid containment vessel 254, and allowing any excess cooking liquid to flow out of liquid containment vessel 254 through exit orifice 266 and into debris collection cup 260.

Lid 278 is comprised of outer plastic lid 280 affixed to inner metal lid 282. As shown best in FIGS. 35 and 37, inner metal lid 282 caps and seals 284 (FIG. 35) the upper opening of food support vessel 250. Seal 284 between inner metal lid 282 and the upper rim of food support vessel 250 may: totally block; or partially block (90% or more of output flow during peak outflow conditions); or minimally block (less than 90% of output flow during peak output conditions); output flow through the upper opening of food support vessel 250.

Preventing or retarding output flow from the interior of food support vessel 250 thru seal 284 may produce beneficial cooking results by creating positive pressure within food support vessel 250, and by helping prevent the outflow of heat, moisture, juices, and flavors. Positive pressure also may help tenderize certain foods.

When placed on top of liquid containment vessel 254, metal lid 282 may also seal against the top side of the upper rim upper of liquid containment vessel 254 helping to prevent cooking liquid leakage, as best shown in FIGS. 35 and 37.

Liquid containment vessel 254 is generally cylindrical. Generally cylindrical herein shall include tubular shapes including, but not limited to, those having six or more regular or irregular sides as well as six or more sided polygonal tubes with soft or hard vertices.

Hood 264 is formed into the forward portion of plastic lid 280 and is configured to direct exhaust exiting through orifice 266 downward into debris collection cup 260.

Debris collection cup 260 may be translucent or transparent to allow users to view the quantity, quality, and identity of its debris content.

Lid latch 286 is rotatably 288 (FIG. 33) mounted to the upper surface of lid 278, and rotates around stub axle 290 (FIG. 38).

Rotating lid latch 286 clockwise 289 (FIG. 33), results in fingers 292 and 294 (FIGS. 38 and 39), disposed at the ends of lid latch 286, to rotate under handle rods 296 and 298 respectively, and thus lock lid 278 onto food support vessel 250. Counterclockwise rotation reverses the engagement.

As best shown in FIG. 33, finger tabs 300 and 302 disposed on the upper surface of lid latch 286, in combination with finger tabs 304 306 308 and 310 which are affixed to the upper surface of plastic lid 280, facilitate one hand operation of lid latch 286 by providing gripping surfaces to rotate lid latch 286 through opposing finger pressure. Lid latch 286 may be rotated locked and unlocked by other means as well, including, but not limited to, rotating central handle 312.

Engagement holes 314 and 316 respectively in the left and right sides of outer enclosure 252 (FIG. 38) provide coupling points for the ends of handle rods 296 and 298 respectively, as shown best in FIG. 31. When so engaged (FIG. 31), the floor of food support vessel 250 is above the surface of cooking liquid contained within food support 250. In this position, liquids may be drained from within food support vessel 250, through orifices 318 (FIG. 39) disposed in the floor of food support vessel 250.

Directly below the floor of food support vessel 250 is filter media 320, which is trapped between the underside of the floor of food support vessel 250, and the top side of the floor of snap-on filter retainer 322, as best shown in FIG. 36.

Filter media 320 may take many forms. As non-limiting and non-exhaustive examples: it may be course or fine screening; cloth; nonwoven material such as steel wool or stainless steel wool; or cotton batting; particles such as sand, metal filings or gravel or activated charcoal particles of various sizes; materials impregnated with activated charcoal or other substances; filter paper; a whole rectangular paper towel (rectangular edges disposed on the outside of food support vessel 250); woven metal; or any other suitable material.

Holes 324 in the floor of filter retainer 322, in combination with filter media 320 and orifices 318 in the floor of food support vessel 250, regulate the flow of liquids and gasses into and out of food support vessel 250.

This regulation helps to suppress bubbling and splattering of hot cooking liquids outside of food support vessel 250 during cooking. It also provides a controlled cooking environment within food support vessel 250, by metering inflow of hot liquids and exhausting of expanded gasses and hot liquids.

Food support vessel 250 may be modified to accept food support shelves similar to food support shelves 224 in embodiment 182. This merely requires the addition of protuberances similar to protuberances 222 to the side walls of food support vessel 250. These shelves would be used in a similar manner, and perform a similar function, to those support shelves 224 in embodiment 182.

Use of embodiment 246 may take many forms. As a first non-limiting and non-exhaustive example, to fry a large food item such as Thanksgiving Day turkey 326, the user would first prepare the turkey in the conventional manner used for oven baking. That is, they would thaw the bird if it is frozen, completely wash and dry both the inside and outside of the bird, and cut off any excess skin.

They will then place the bird into food support vessel 250 either feet up or feet down, and place and lock lid 278 on top of food support vessel 250, and then slowly lower the combination into frying temperature cooking oil contained within liquid containment vessel 254, were it will remain for a period long enough for turkey 326 to cook.

After cooking is complete, food support vessel 250, along with its turkey contents, are lifted out of the hot cooking liquid contained within liquid containment vessel 254, and the ends of handle rods 296 and 298 are placed into engagement hole 314 and engagement hole 316 respectively. Placing food support vessel 250 in this position for a few seconds to more than a minute, allows excess liquid to drain away from turkey 326.

After such draining, turkey 326 may be removed from food support vessel 250 and served.

Marinades, brining, spices, and other food preparations may be used before, during, or after cooking has occurred.

After cooking, the contents of debris collection cup 260 may be removed and reused, or disposed of Debris collection cup 260, and condensation surfaces 276, food support vessel 250, lid 278 and liquid containment vessel 254 may all then be cleaned.

FIGS. 40 through 43—Embodiment 328:

FIGS. 40 through 43 show embodiment 328, which is a compactable funnel with other functions as well.

Embodiment 328 is fundamentally pliable sheet 334 which can be flexed into various useful forms.

FIG. 42 shows a plan view of embodiment 328 flattened out. In this form, embodiment 328 may be compactly stored. This form also allows embodiment 328 to be used as a cutting board and food preparation surface.

FIG. 43 shows that after cutting foods or otherwise preparing them, pliable sheet 334 can be formed into a U-shaped trough which allows the prepared foods as non-limiting and non-exhaustive examples, to be dumped into storage containers or onto other food items, such as onto a salad.

FIG. 40 shows embodiment 328 flexed into a funnel, with wide upper opening 330 and narrow lower exit orifice 332. To do this formation, pliable sheet 334 is flexed into a conical shape, and corner tab 336 is inserted into slot 338, or slot 340, or slot 342, depending on how steep the inclination of the sidewalls of the funnel is desired to be, with slot 338 giving the steepest angle of inclination, and slot 342 giving the widest upper opening 330.

Living hinge 346, disposed at the base of corner tab 336 makes insertion of tab 336 into one of the three slots (338, 340, 342) easier.

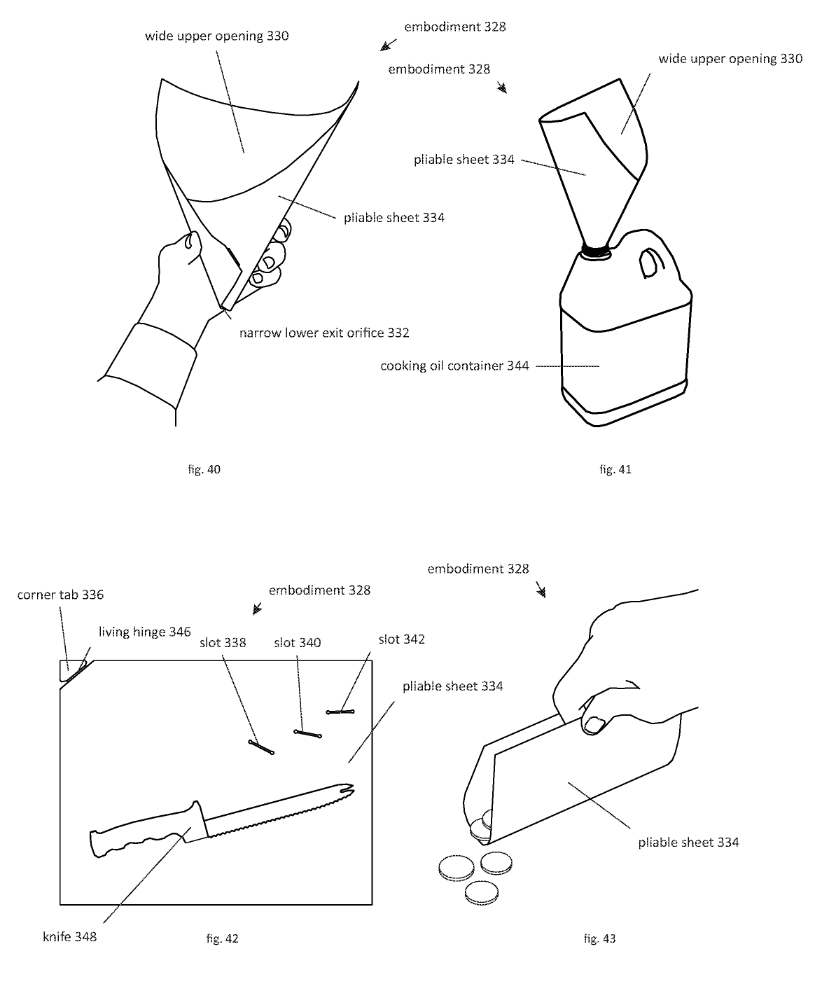

FIG. 41 shows embodiment, in its funnel configuration, being used to refill cooking oil container 344 with used oil.

Embodiment 328 may be fabricated in many different ways. As a non-limiting and non-exhaustive examples, it may be die stamped or injection molded in 0.030″ thick polypropylene with a pebble finish on at least one side to facilitate cutting and cleaning.

Knife 348 in FIG. 42 is shown for purposes of illustrating embodiment 328 being used as a cutting board.

### Recapping:

Embodiments to deep fat fry comestibles, including large food items. Such embodiments potentially being versatile enough to at least: deep fry, steam, bake, slow cook, and boil foods. Embodiments utilizing a horizontal trough with radiused floors and sidewalls. Such embodiments comprising opposing parallel sidewalls and level floors, as well as comprising tapering sidewalls, and sloping floors, and combinations thereof. Embodiments comprising contained food support vessels immersed into frying temperature cooking liquid baths, as well as boiling water, as well as hot air. Foods cooked in multiple single immersions into hot cooking liquid, as well as foods cooked using a process where foods are cooked a single portion of the food at a time until the entire food is fully cooked. Automatic fryer cleaning systems, utilizing food support vessels which drain through filter media. Such systems automatically filtering cooking liquid during each use session. Such systems automatically filtering cooking liquids before debris the cooking liquids contain can contact and be deposited on: heat coils, thermal sensors, and oil containment vessels; thereby significantly easing cleanup. Contained food support vessels capped by lids which easily configure into closed and open positions. Unitary filter media configured to selectively remove debris and pollutants from both gasses and liquids exiting food support vessels. Various filtering media including common rectangular paper towel sheets. Reusable filter media of various types. High-capacity steaming apparatus. Condensation filtering into easy to empty and clean collection cups. Easy to clean and handle condensation filter media. Safety cooking liquid overflow protection into easily to empty and clean cups. Collection of overflowed cooking liquids for easy reuse or disposal. Simplified fryer construction. High cooking liquid efficiency embodiments utilizing minimal cooking liquid to cook both large and small food items, as well as to cook large and small amounts of unitary and plural foods. A versatile, compactable funnel which may double as a cutting and food preparation surface.

1. A device to cook large fowl, comprising:
a vessel configured to hold an associated fowl on its side with one wing and one leg downward, and associated cooking liquid,
a heat source in communication with the vessel, and the heat source configured to heat cooking liquid and associated fowl to be cooked in the cooking liquid within the vessel to cooking temperatures, and a fowl support configured to support a fowl on its side, with the fowl having one wing and one leg downward, while the fowl is disposed in the vessel.

2. The device of claim 1, wherein the vessel comprises two generally planar opposing side walls coupled by a trough-like rounded floor.

3. The device of claim 2, wherein the two generally planar opposing side walls are substantially parallel to one another.

4. The device of claim 2, wherein the two generally planar opposing side walls converge end to end toward one another.

5. The device of claim 1, wherein the vessel comprises two generally planar opposing side walls coupled at each of their ends by two opposing generally vertical and cylindrical end walls.

6. The device of claim 1, wherein the vessel includes a trough-like rounded floor, and the floor is generally horizontal end to end.

7. The device of claim 1, wherein the vessel includes a trough-like rounded floor, and the floor is generally inclined end to end.

8. The device of claim 1, wherein the fowl support is comprised of an open topped container with perforated container walls in its lower 30%.

9. The device of claim 8, wherein the open topped container has substantially imperforate container walls in its upper 70%.

10. The device of claim 1, wherein the fowl support is comprised of an open topped container, and the open topped container comprises two opposing container walls configured to compress against a bottom and top of large fowl being cooked therein so as to reduce a bottom to top dimension of such large fowl by at least 3% when compared to the same large fowl resting horizontally on its breast on a horizontal support surface.

11. The device of claim 1, further including a nonstick coating disposed on interior surfaces of the open topped container.

12. The device of claim 1 further comprising a collection cup configured to receive exhaust leaving the vessel during cooking.

13. The device of claim 12, wherein there are non-peripheral wall, surfaces of the collection cup that are configured to condense vaporous components of the exhaust.

14. A device to deep fry comestibles, comprising:
a cooking vessel configured to simultaneously hold frying liquid, and associated comestibles to be fried in the frying liquid,
a heat source, in communication with the cooking vessel, configured to heat frying liquid and associated comestibles to be fried in the frying liquid to frying temperatures,
an open topped food support vessel, configured to be at least partially disposed within the cooking vessel, and configured to completely hold associated comestibles to be fried within the food support vessel, and the food support vessel being imperforate in an upper 70% of its structure,
a user removable lid configured to block an open top of the open topped food support vessel.

15. The device of claim 14, wherein there is a lock configured to lock the user removable lid onto the open top of the food support vessel.

16. The device of claim 14, further including one or more orifices penetrating a lower 30% of the food support vessel, the orifices being configured to regulate fluid flow into the food support vessel.

17. The device of claim 16, further including filtering media disposed proximate to the orifices, and the filtering media configured to intercept and filter fluid flowing out of the food support vessel through the orifices.

18. The device of claim 14, further including one or more user removable food support shelves, directly supported by, and disposed within, the food support vessel.

19. An apparatus to filter exhausts from a cooking device, comprising:
an enclosed cooking chamber configured to hold comestibles to be cooked,
a heating source configured to heat comestibles within the chamber to cooking temperatures,
an upward opening debris collection cup configured to receive exhausts from the enclosed cooking chamber, and
means to direct exhausts leaving the enclosed cooking chamber into the interior of the debris collection cup.

20. The apparatus of claim 19, wherein the debris collection cup is removably coupled to the enclosed cooking chamber.

21. The apparatus of claim 19, wherein the debris collection cup is configured to accept vapors and gasses exiting from the enclosed cooking chamber.

22. The apparatus of claim 19, wherein the debris collection cup is configured to accept liquids exiting from the enclosed cooking chamber.

23. The apparatus of claim 19, wherein the debris collection cup is this comprised of translucent or transparent peripheral walls.

24. The apparatus of claim 19, wherein the debris collection cup is configured to be dishwasher cleanable.

25. The apparatus of claim 19, wherein the debris collection cup comprises internal peripheral walls configured to condense components of the exhaust from the enclosed cooking chamber.

26. The apparatus of claim 25, wherein the debris collection cup comprises surfaces distinct from internal peripheral walls, which surfaces are configured to condense components of the exhaust exiting from the enclosed cooking chamber.

27. A device to deep fry comestibles, comprising:
a generally cylindrical outer enclosure which surrounds and supports a generally cylindrical cooking vessel,
a generally cylindrical cooking vessel configured to hold comestibles to be fried and associated frying oil,
a heat source configured to heat to frying temperatures, comestibles to be fried and associated frying oil while both are disposed within the cooking vessel,
an open at each end tubular member penetrating the side walls of both the cooking vessel and the outer enclosure, the tubular member configured to allow passage of liquids and gasses from inside the cooking vessel to the exterior of the outer enclosure, and the tubular member being disposed directly below the upper rim of the cooking vessel.

28. The device of claim 27, wherein there is an upward facing collection cup, and the collection cup is configured to receive into its interior, liquids and gasses passing through at each end,
means to direct liquids and gasses exiting the cooking vessel and passing through the open at each end tubular member, into the interior of the collection cup.

29. A device to facilitate the pouring of liquids and powders, comprising:
a generally rectangular, pliable sheet,
the generally rectangular sheet having an insertion tab formed on one of its four corners,
a slot penetrating the sheet, and the slot configured to accept, and removably snap fit couple to, the insertion tab,
the rectangular, pliable sheet being configured to flex into a form having generally conical outer walls when the insertion tab is coupled through the slot.

30. The device of claim 29, wherein the slot is plural.

31. The device of claim 29, wherein the sheet is configured to resist destruction when a sharp blade is run across its upper surface.

32. The device of claim 29, wherein the sheet is configured to flex into a U-shaped trough.
